(19) United States
(12) Patent Application Publication
(10) Pub. No.: US 2003/0018516 A1
(43) Pub. Date: Jan. 23, 2003

(54) Method for dynamically evaluating projected days of supply of inventory levels in a supply chain

(75) Inventors: Roberto Ayala, Yorktown Heights, NY (US); Michael P. Murray, Ridgefield, CT (US); Mauricio Alejandro Villalobos, Hopewell Junction, NY (US)

Correspondence Address: Philmore H. Colburn II, Cantor Colburn LLP, 55 Griffin Road South, Bloomfield, CT, 06002, US

(73) Assignee: International Business Machines Corporation, Armonk, NY

(21) Appl. No.: 09/909,686

(22) Filed: Jul. 20, 2001

(51) Int. Cl. G06F 17/60

(52) U.S. Cl. 705/10

(57) ABSTRACT

An exemplary embodiment of the invention relates to a method for managing inventory of a stock item over a number of convenient time periods. The method comprises receiving an updated demand forecast and updating projected forecast data; determining for a given time period: projected inventory level using the projected forecast data, supplier commitment data, and prior periods' projected inventory levels; and days of supply of inventory using the projected inventory level for a current period and forecast data for subsequent periods. If the days of supply is out of a predetermined range for a given time period, then corrective actions are taken. Corrective actions include modifying the supplier commitment data by increasing the amount of commitment or delaying shipments.

### BACKGROUND

This invention relates generally to inventory management processes in a supply chain, and more particularly, the present invention relates to a method for dynamically determining projected days of supply of inventory.

Two problems facing supply chains today include: having insufficient quantities of materials on hand to satisfy customer demand which, in turn, can jeopardize a company's ability to do business, and having surplus inventory which is often derived from the effort undertaken to reduce the risks associated with not having enough materials. Having a surplus inventory causes a hold of cash and increases the risk of loss in assets due to factors such as obsolescence. Other causes of risk include unplanned or unexpected orders for goods, as well as order cancellations which may also impact inventory levels. It is more common, however, that factors not attributable to customer behavior are the cause of inventory management problems. Businesses are continuously striving to find new and better ways to improve their inventory management processes in order to reduce these business risks.

One of the reasons why current inventory management systems fail is due to ineffective demand forecasting methods and deficient supply replenishment processes utilized by supply management teams across many industries. Predicting future demand for goods and materials is fraught with uncertainties which are further fueled by dynamic economic conditions and fluctuating markets. This instability can make forecasting future supply needs especially difficult for the manufacturing industry. For example, if the manufacturer finds either an increased or reduced demand in the product compared to its forecast, strain is placed throughout the supply chain where overstocking or depletion of components can occur quickly. In addition, if the supplier cannot deliver the components, manufacturers will often not be able to react quickly to meet demand, seek alternative sources, etc. Without keeping large stock of components on hand at the manufacturer's site, supply problems occur readily. However, keeping a large stock has additional problems of its own, such as higher storage costs, an increased loss probability because components become outdated, etc. Moreover, electronic parts tend to reduce in value with time (i.e., a part that the manufacturer purchases in January will cost less in March and much less in June and so on).

One solution developed to improve existing inventory management systems includes the establishment of storage warehouses or replenishment centers for facilitating quick and easy access to goods creating a buffer in the event of a sudden change in demand. Liability for maintaining and delivering these materials from the warehouse to the manufacturer typically remains with the supplier until a fixed point in time such as when the goods are ordered or a demand statement is issued by the purchasing manufacturer. The manufacturer benefits by reducing the costs associated with keeping inventory on hand and enhancing replenishment capabilities. By adding a third player (i.e., the warehouse) to the mix, however, additional problems in inventory management are presented. For example, coordinating supply requirements and forecasts, changes to these requirements, and their corresponding delivery schedules can be cumbersome and prone to error. Multi-party communications between supplier, warehouse, and buyer must be consistently accurate and reliable otherwise a breakdown in the supply chain can occur creating a ‘chain effect’ of inventory delays, and/or inaccuracies.

Software systems have been developed to address inventory replenishment problems utilizing various techniques. Internal Material Requirements Planning (MRP) or Enterprise Resource Planning (ERP) systems have been implemented to manage component supply and demand based on a forecast prepared by the manufacturer. As stated above, however, forecasts are imprecise, and often subject to change. In recent years, to better match actual production with forecasts calculated by the MRP system, a Just-in-Time (JIT) concept was developed. In a JIT environment, a network of phones and faxes is used to monitor each point in an assembly line where someone would be responsible for counting each set of components as they are assembled into a product (i.e. a manual pull system). Thereby, the responsible party would order additional components by phone or fax as components are running short, based on planned levels developed through past experiences and history. However, such JIT systems require constant monitoring, and still are highly dependent on accurate forecasts. Further, in a JIT environment when changes in demand are relayed through the supply chain from final product assemblers to the subassembly suppliers and ultimately to the component suppliers, even the slightest delay in communications can have a devastating impact on the integration and synchronization capabilities of the supply chain.

One popular trend in inventory management has evolved in an effort to alleviate some of the concerns associated with inventory management problems and is referred to as vendor managed inventory. Vendor managed inventory (VMI) solutions typically enable a retailer to downstream its inventory management processes to its suppliers in order to reduce the risks associated with surplus inventories and underages in inventory levels. VMI attempts to reduce these risks by monitoring retailer stock levels and planning inventory replenishment activities based upon forecast data and current stock figures.

Although better forecasting tools have been developed over the years, replenishment issues have remained a problem for many manufacturers. As the manufacturing world begins to move to build-to-order environment, greater demands are expected from the manufacturer to lower total costs in the complete supply chain, shorten throughput times, reduce stock to a minimum and provide more reliable delivery dates without constraining production due to supply issues.

### BRIEF SUMMARY

An exemplary embodiment of the invention relates to a method for managing inventory of a stock item over a number of convenient time periods. The method comprises receiving an updated demand forecast and updating projected forecast data; determining for a given time period: projected inventory level using the projected forecast data, supplier commitment data, and prior periods' projected inventory levels; and days of supply of inventory using the projected inventory level for a current period and forecast data for subsequent periods. If the days of supply is out of a predetermined range for a given time period, then corrective actions are taken. Corrective actions include modifying the supplier commitment data by increasing the amount of commitment or delaying shipments.

### BRIEF DESCRIPTION OF THE DRAWINGS

Referring now to the drawings wherein like elements are numbered alike in the several FIGURES:

FIG. 1 is a block diagram of a portion of a network system upon which the projected days of supply inventory management tool is implemented in a preferred embodiment; and

FIG. 2 is a flowchart describing how the projected days of supply inventory management tool evaluates projected days of supply of inventory levels over a supply chain network in a preferred embodiment.

### DETAILED DESCRIPTION OF THE PREFERRED EMBODIMENT

An exemplary embodiment of the invention relates to a method for managing inventory processes over a supply chain network by utilizing a projected days of supply inventory management tool. Daily, Weekly or Monthly forecasts for each period in the planning horizon, supplier commitments for each period, and inventory on hand data are routinely updated and evaluated for establishing an optimum inventory replenishment operation. Information is shared and updated by all parties within the supply chain for enabling the most accurate and up-to-date inventory projections. Supply chain partners work together to maintain minimum baseline projected days of supply availability.

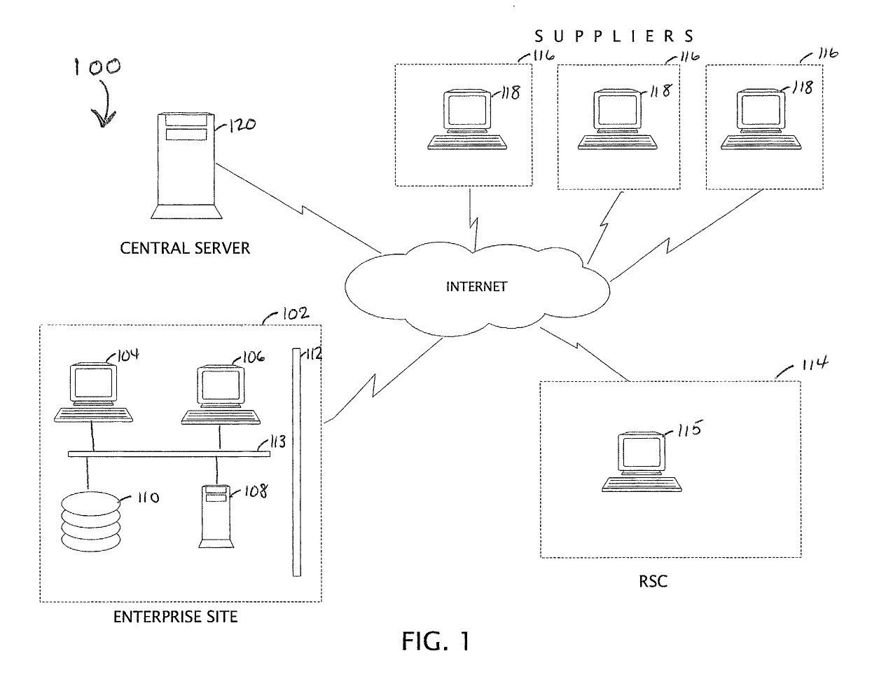

In an exemplary embodiment, the projected days of supply inventory management tool is implemented via a computer network system such as that depicted in FIG. 1. System 100 includes an enterprise site 102 which represents an electronics manufacturing facility for a business enterprise, although it will be understood that additional enterprise sites may be included in system 100 in order to realize the advantages of the invention. The business enterprise of FIG. 1 may be a large manufacturing company with manufacturing sites located all over the globe. Thus, enterprise site 102 represents one of the facilities operated by the business enterprise. Enterprise site 102 includes a client system 104 which represents a manufacturing group within enterprise site 102. The term ‘group’ signifies a product, commodity, or specialty manufacturing group associated with a business enterprise which shares some common tasks or business objectives. For example, in a manufacturing environment, one group may be Consumer Products, and a second group may be High Technology Products. Thus, client system 106 signifies a second group for enterprise site 102. Client systems 104 and 106 request applications and data from a server 108 via what is commonly referred to in the art as a client/server architecture. It will be understood that any number of client systems and/or groups may be employed by enterprise site 102.

Server 108 executes the business enterprise's Material Requirements Planning (MRP) and/or Enterprise Resource Planning (ERP) applications, among other tools or applications suites desired. Applications such as web server software and groupware tools are executed by server 108 for facilitating communications within site 102 as well as between site 102 and external entities. Further, server 108 is executing database management software for communicating with data storage device 110. Data storage device 110 serves as a repository for a range of databases and data utilized by site 102 and which will be further explained herein. A communications link 113 is also included in site 102 which allows client systems 104 and 106, data storage device 110, and server 108 to communicate with another. Communications link 113 may be a high speed local area network such as an Ethernet, token ring, or OSI model network. In a system where more than one site 102 exists, a wide area network (WAN) linking sites together via routers, gateways, or similar software and/or hardware devices may be employed (not shown). A firewall 112 filters out unauthorized communication attempts by external entities and provides data integrity of system resources of site 102. Central server 120 is also included in system 100 and provides a centralized system and location for directing and coordinating the activities implemented by the projected days of supply inventory management tool as well as other system resources desired by the business enterprise. Server 120 may be a collection of high powered computers employing multiple processors, including scalable memory and high speed capabilities. In smaller manufacturing organizations, the processes described with respect to central server 120 may alternatively be performed by server 108 at the enterprise site location of enterprise site 102. Server 120 is preferably executing applications including a central MRP engine, an optimization tool, and a supplier collaboration tool, in addition to the projected days of supply inventory management tool of the invention. The supplier collaboration tool may be a commercially obtained product for implementing supply collaboration functions or may be the supplier collaboration tool disclosed in U.S. Patent Application Attorney Docket Number YOR9-2001-0274US1, filed on Jul. 20, 2001, entitled “Network-Based Supply Chain Management Method”, which is incorporated herein by reference in its entirety.

The supplier collaboration tool of the above-referenced application discloses a tool that receives projected forecast data from various groups of a business enterprise which may span several enterprise site locations. The forecast data is aggregated from different manufacturing locations and an unconstrained group level forecast is generated there from. This unconstrained forecast is then transmitted back to associated suppliers for supply capability assessment. Supplier capability responses received by these suppliers are optimized at enterprise level and exploited again, resulting in the generation of a constrained forecast which is transmitted to suppliers at the individual site level. Commitment responses received from suppliers are processed and a site specific build plan is generated and implemented via the supplier collaboration tool. Modifications to build plans are effectuated when desirable via the supplier collaboration tool and supply replenishment activities are carried out accordingly.

Replenishment service center (RSC) 114 provides local storage of supplier goods and inventory under an agreement with site 102. RSC 114 may be a warehouse or commercial storage facility. In a preferred embodiment, RSC 114 includes client system 115 which is Internet-enabled and which operates; web browser software for communicating with site 102 and suppliers 116. RSC 114 executes a warehouse management (WMS) tool for managing its inventory processes and replenishment activities according to agreements established between RSC 114, suppliers 116, and enterprise site 102, as well as replenishment plans developed by the supplier collaboration tool and the inventory management projected days of supply tool. Client system 115 includes data storage for housing records generated by activities conducted via the WMS tool, the supplier collaboration tool, and the projected days of supply inventory management tool. RSC 114 receives requests for goods and data related to inventories from enterprise site 102 and/or suppliers 116.

Suppliers 116 provide goods to enterprise site 102 and manage inventory levels of goods stored at RSC 114. Suppliers 116 include client systems 118 which are Internet-enabled and operate web browser software. Alternatively, a client/server architecture may be employed by RSC 114 and/or suppliers 116 in order to achieve the advantages of the present invention. Such network architectures are commonly employed in business and will be appreciated by those skilled in the art.

RSC 114 is strategically located in close proximity to site 102 in order to provide quick inventory deliveries as needed. RSC 114 may also be responsible for servicing additional sites of the business enterprise that are also located nearby in addition to site 102 if desired. Suppliers 116 provide goods to site 102 via RSC 114 based upon demand requirements for and/or agreements with site 102. Suppliers 116 ensure adequate supply levels of goods at RSC 114 via network communications facilitated by the supplier collaboration tool and inventory management projected days of supply tool as will be described further herein.

In an exemplary embodiment, projected days of supply inventory management is provided via a shared communications infrastructure; namely, a trade network environment such as system 100. Enterprise site 102 communicates with suppliers 116 and RSC 114 relating to its inventory requirements which information is then used by the projected days of supply inventory management tool to calculate whether changes in supplier inventory commitments are necessary or desirable. The tool also highlights if the projected days of supply numbers are out of a predefined range, suggesting that the supplier take action to increase inventory at the RSC or delay shipments. Forecasts, commitments, and inventory level data are provided and tracked by all entities within the supply chain and may be stored centrally in data storage device 110 for evaluation and maintenance. Current inventory supply levels are continuously monitored and forecast data and supplier commitments are periodically reevaluated in order to maintain accurate up-to-date forecasts and replenishment capabilities.

Supplier collaboration processes involve communicating material requirements forecasts to suppliers in order for them to assess their supply capabilities against that forecast and to communicate those capabilities back to the business enterprise. This process may be repeated as often as necessary in order to achieve accurate collaborative planning results. A constrained forecast is generated and provided to suppliers, via the web or transmitted over some transmission medium, such as over electrical wiring or cabling, through fiber optics, or via electromagnetic radiation. Suppliers then respond with a formal commitment. This formal commitment from the suppliers reflects what they will build to. Suppliers may agree to maintain a minimum supply level usually measured in terms of days of supply (DOS) at each enterprise site's RSC. For example, a supplier may agree to continuously maintain ten days of supply at the RSC. Inventory levels may be measured in DOS by rationalizing actual units of inventory, against expected consumption (constrained forecast). Inventory levels are monitored in each RSC and refilled as needed to maintain the agreed level of inventory buffer. Each time materials are shipped from the supplier to the RSC and also from the RSC to the enterprise site, the projected days of supply inventory management tool recalculates the projected days of supply levels and updates the existing inventory records.

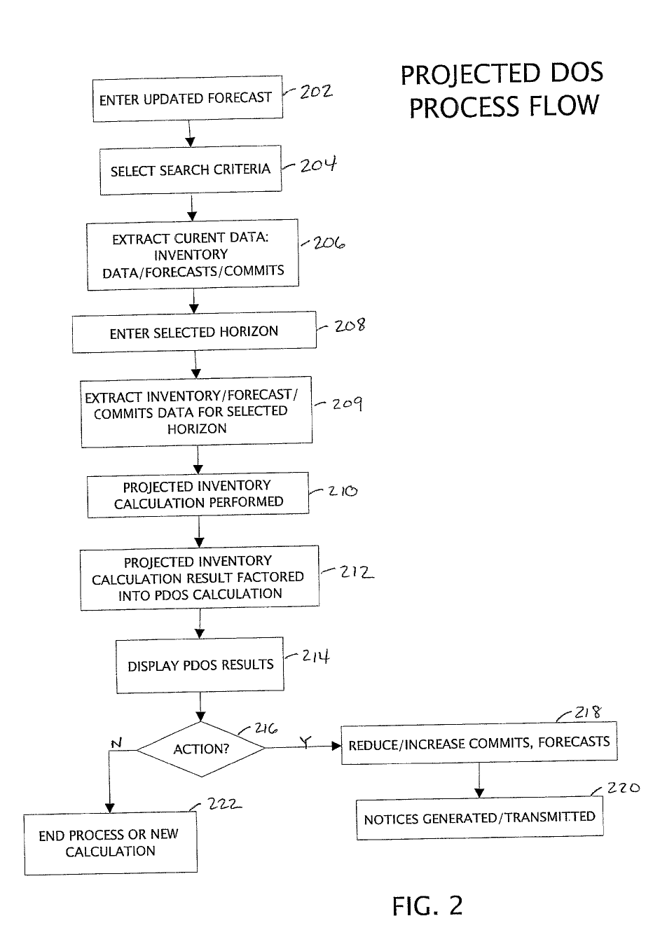

FIG. 2 illustrates the projected days of supply process utilized by the inventory management tool. Projected days of supply and projected inventories at the beginning of a cycle are dynamic and should be calculated each time there is a change in a forecast, a supplier commitment or inventory levels at the RSC. The tool may also provide for determining and evaluating a projected days of supply range according to part number and highlighting when that projected days of supply figure is out of range for that part number.

A user initiates the process by entering the updated forecast for each period as a result of a new planning cycle into client system 104 at step 202 followed by selecting a search criteria at step 204. As discussed above, criteria available for determining projected days of supply may include part number, part name, and/or description. The projected days of supply inventory management tool extracts current data related to the search criteria entered for analysis at step 206. The tool then requests that the user enter the selected horizon at step 208. The selected horizon represents the point in time for which the user desires to calculate projection needs utilizing both current and forecasted data. The horizon includes a collective group of time periods established for analysis or review. The tool retrieves inventory data, forecast data and commits data from data storage device 110 and/or RSC storage according to the selected horizon reviewed at step 209. The commits number represents the quantity of materials or parts that supplier 116 has committed to provide to enterprise site 102 and which supplier 116 maintains in RSC 114. Forecast data is acquired by any desired technique suitable for enterprise site 102 and represents the quantity of materials that enterprise site 102 expects to consume for the period of time specified (e.g., the current week).

Projected inventory analysis is then performed at step 210 and includes subtracting the forecast data for the previous period from the inventory data extracted at step 206. The tool then adds this figure to the commits data from the previous period which results in a number herein referred to as ‘projected inventory level’ or simply, ‘projected inventory’ based upon information known at the current period. The projected inventory figure for a first period is the current inventory level at the RSC. The formula used to perform a projected inventory analysis for a second and subsequent period may be expressed as follows where ‘PI’ represents a projected inventory, ‘F’ represents a forecast, ‘C’ represents a commitment, and ‘n’ represents a variable describing a period selected:

PI(n)=PI(n−1)−F(n−1)+C(n−1).

A forecast period may be in days, weeks or months, the value of the days in the period are the working days in that period (e.g., 1 if forecast period is in days; 5, 6, or 7 if the forecast period is in weeks; and 20, 24, or 30 if the forecast period is in months). The projected days of supply inventory management tool captures the projected days of supply range which has been specified for a particular inventory item.

Once the projected inventory calculation has been performed for the selected horizon being evaluated, the projected days of supply inventory management tool then uses the result of the previous calculation (i.e., the projected inventory calculation) to translate the result in projected days of supply via a projected days of supply calculation at; step 212. The projected days of supply calculation is preferably considered at the beginning of the period.

The formula utilized to calculate the projected days of supply for each period may be expressed as follows whereby ‘PDOS’ represents the projected days of supply for the period, ‘CI’ represents a coverage inventory, said coverage inventory will be initialized with the projected inventory at the beginning of the period; ‘i’ is an index in which ‘i’ represents a number from 0 to ‘n’, ‘DP’ represents a number of days in the period, ‘F’ represents forecasts in the period, and ‘n’ represents a variable describing a period selected:

PDOS(n)=DP*(i+CI/F(n+i))

For each period (n) in the selected horizon, a repetitive calculation is utilized while the coverage inventory (CI) remains greater than zero. The repetitive calculation includes subtracting from CI the forecast of the period (n+i) and adding ‘1’ to an index (i).

The projected days of supply inventory management tool displays the results of the calculations at step 214. As described above, acceptable ranges of PDOS may be established via the projected days of supply inventory management tool whereby actions may be taken in response to the PDOS calculation results at step 216.

If the projected days of supply is outside of the acceptable range, the enterprise evaluates the commits and/or forecast data and establishes either a reduced or increased requirement for transmittal to the associated supplier 116 and/or RSC 114 at step 218. In this manner, supplier 116 has notice that the number of units it has previously committed to needs to be revised via notices generated and transmitted at step 220.

Alternatively, if the projected inventory is within the acceptable range, this means that the projected inventory levels estimated is sufficient to meet future projected forecasts and no further action is required for the current week at step 222. Additional evaluations may then be performed.

In an alternative embodiment, the projected days of supply tool may perform the processes described in FIG. 2 automatically upon the happening of an event such as a change in demand forecast, a change in supplier commitments, and/or a change in inventory levels brought on by stock items delivered. In yet another embodiment, the processes described in FIG. 2 may be performed by the supplier and/or the replenishment service center utilizing the projected days of supply inventory management tool.

The tool allows a user to dynamically examine and revise realistic projected days of supply based upon data provided by the tool. This information may be highly volatile and therefore, continuous assessments may be necessary in order to maintain accurate projections. By continuously monitoring inventory levels, forecasts, commits, etc., and sharing this information with supply chain partners, an enterprise is better able to leverage supply levels and capital requirements in a competitive manner.

As described above, the present invention can be embodied in the form of computer-implemented processes and apparatuses for practicing those processes. The present invention can also be embodied in the form of computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. The present invention can also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While preferred embodiments have been shown and described, various modifications and substitutions may be made thereto without departing from the spirit and scope of the invention. Accordingly, it is to be understood that the present invention has been described by way of illustration and not limitation.

1. A method for managing inventory of a stock item over a number of convenient time periods, comprising:
receiving an updated demand forecast and updating projected forecast data;
determining for a given time period:
projected inventory level using said projected forecast data, supplier commitment data, and prior periods' projected inventory levels; and
days of supply of inventory using said projected inventory level for a current time period and forecast data for subsequent periods; and
if said days of supply is out of a predetermined range for a given time period, taking corrective action.

2. The method of claim 1, wherein said given time period is established by at least one of:
a supplier; and
a manufacturer.

3. The method of claim 1, wherein said determining for a given time period said projected inventory level includes providing a search criteria including a part number identifying said stock item.

4. The method of claim 3, wherein said search criteria includes a part name identifying said stock item.

5. The method of claim 3, wherein said search criteria includes a part description identifying said stock item.

6. The method of claim 1, wherein said number of convenient time periods includes a selected horizon.

7. The method of claim 1, wherein said number of convenient time periods is measured in increments of time, said increments including one of:
days;
weeks; and
months.

8. The method of claim 1, wherein said projected forecast data includes a quantity of said stock item expected to be consumed during at least one of said number of convenient time periods.

9. The method of claim 1, wherein said supplier commitment data includes a quantity of said stock item a supplier commits to provide for a manufacturer.

10. The method of claim 1, wherein said determining for a given time period said projected inventory level includes performing a calculation comprising:
PI(n)=PI(n−1)−F(n−1)+C(n−1);
wherein further:
PI represents a projected inventory value;
n represents a variable, said variable representing a time period;
F represents a projected forecast value; and
C represents a supplier commitment value.

11. The method of claim 1, wherein said predetermined range for said projected days of supply is established by at least one of:
a manufacturer; and
a supplier.

12. The method of claim 1, wherein said predetermined range for said projected days of supply is a single number.

13. The method of claim 1, wherein said days of supply is measured in time increments including one of:
days;
weeks; and
months.

14. The method of claim 1, wherein said corrective action includes modifying said supplier commitment data.

15. The method of claim 14, wherein said modifying said supplier commitment data includes delaying a shipment.

16. The method of claim 14, wherein said modifying said supplier commitment data includes increasing said supplier commitment data.

17. A storage medium encoded with machine-readable computer program code for managing inventory of a stock item over a number of convenient time periods, the storage medium including instructions for causing a computer to implement a method, comprising:
receiving an updated demand forecast and updating projected forecast data;
determining for a given time period:
projected inventory level using said projected forecast data, supplier commitment data, and prior periods' projected inventory levels; and
days of supply of inventory using said projected inventory level for a current time period and forecast data for subsequent periods; and
if said days of supply is out of a predetermined range for a given time period, taking corrective action.

18. The storage medium of claim 17, wherein said given time period is established by at least one of:
a supplier; and
a manufacturer.

19. The storage medium of claim 17, wherein said determining for a given time period said projected inventory level includes providing a search criteria including a part number identifying said stock item.

20. The storage medium of claim 19, wherein said search criteria includes a part name identifying said stock item.

21. The storage medium of claim 19, wherein said search criteria includes a part description identifying said stock item.

22. The storage medium of claim 17, wherein said number of convenient time periods includes a selected horizon.

23. The storage medium of claim 17, wherein said number of convenient time periods is measured in increments of time, said increments including one of:
days;
weeks; and
months.

24. The storage medium of claim 17, wherein said projected forecast data includes a quantity of said stock item expected to be consumed during at least one of said number of convenient time periods.

25. The storage medium of claim 17, wherein said supplier commitment data includes a quantity of said stock item a supplier commits to provide for a manufacturer.

26. The storage medium of claim 17, wherein said determining for a given time period said projected inventory level includes performing a calculation comprising:
PI(n)=PI(n−1)−F(n−1)+C(n−1);
wherein further:
PI represents a projected inventory value;
n represents a variable, said variable representing a time period;
F represents a projected forecast value; and
C represents a supplier commitment value.

27. The storage medium of claim 17, wherein said predetermined range for said projected days of supply is established by at least one of:
a manufacturer; and
a supplier.

28. The storage medium of claim 17, wherein said predetermined range for said projected days of supply is a single number.

29. The storage medium of claim 17, wherein said days of supply is measured in time increments including one of:
days;
weeks; and
months.

30. The storage medium of claim 17, wherein said corrective action includes modifying said supplier commitment data.

31. The storage medium of claim 30, wherein said modifying said supplier commitment data includes delaying a shipment.

32. The storage medium of claim 30, wherein said modifying said supplier commitment data includes increasing said supplier commitment data.
